(19) United States
(12) Patent Application Publication
(10) Pub. No.: US 2026/0142886 A1
(43) Pub. Date: May 21, 2026

(54) METHOD AND APPARATUS FOR MANAGING SWITCHING BETWEEN STANDALONE AND NON-STANDALONE NETWORKS

(71) Applicants: AT&T Intellectual Property I, L.P., Atlanta, GA (US); AT&T Mobility II LLC, Atlanta, GA (US)

(72) Inventors: Hongyan Lei, Plano, TX (US); Ye Chen, Marietta, GA (US); Yupeng Jia, South Pasadena, CA (US); Nabeel Mir, SOUTHLAKE, TX (US)

(73) Assignees: AT&T Intellectual Property I, L.P., Atlanta, GA (US); AT&T Mobility II LLC, Atlanta, GA (US)

(21) Appl. No.: 18/952,537

(22) Filed: Nov. 19, 2024

(51) Int. Cl. H04L 41/147; H04W 24/02; H04W 48/18

(52) U.S. Cl. CPC H04L 41/147; H04W 24/02; H04W 48/18

(57) ABSTRACT

Aspects of the subject disclosure may include, for example, analyzing data by applying AI modeling to the data where the analyzing includes analyzing network conditions at a SA network and an NSA network resulting in analyzed network conditions; predicting a better user experience for a communication session of an end user device based on the analyzed data resulting in a prediction; selecting one of the SA network or the NSA network for the end user device based on the prediction resulting in a selected network; determining a time period for the end user device to continue utilizing the selected network for future communication sessions; and providing an instruction to a network element that causes the end user device to connect to the selected network, where the end user device utilizes the selected network for the communication session and the future communication sessions during the time period. Other embodiments are disclosed.

### FIELD OF THE DISCLOSURE

The subject disclosure relates to a method and apparatus for managing switching between standalone and non-standalone networks such as between 4G and 5G, 5G and 6G, and other switching between technologies.

### BACKGROUND

In areas with multiple network coverage, users often experience suboptimal connectivity and frequent network transitions. This can lead to disruptions in user experience, inefficient use of network resources, and increased power consumption for devices. The challenge is to enhance user experience and network efficiency by managing the transition between different network layers more effectively.

Existing solutions often fail to address the need for a seamless and efficient transition between these network layers. Users may experience frequent and unnecessary switching, leading to network instability and increased signaling overhead. Additionally, current methods do not adequately consider the varying capabilities of different devices, which can result in suboptimal user experiences. There is a need for a more intelligent and flexible approach to manage these transitions, ensuring better user experience and optimized or improved network performance.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIGS. 2B-2D are block diagrams illustrating example, non-limiting embodiments of communication processes functioning within the communication network of FIG. 1 and the system of FIG. 2A in accordance with various aspects described herein.

FIGS. 2E-2F are block diagrams illustrating example, non-limiting embodiments of messages and Information Elements that can be used with the communication network of FIG. 1 and the system of FIG. 2A in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for enhancing user experience and network performance in areas with both Standalone (SA) (e.g., 5G) and Non-Standalone (NSA) (e.g., LTE/NSA) coverage, as well as other RATs (e.g., a 6G operating as a SA and a 5G operating as the NSA; or 6G operating as SA and 5G as SA). Many of the examples described herein are described with respect to a 5G SA network and an LTE/NSA network, however, other RATs can also be utilized for the SA and/or NSA network. In one or more embodiments, the communication devices that are being switched and returned between the NSA and SA networks can be IoT devices or other communication devices such as mobile phones.

In one embodiment, Generative Artificial Intelligence (Gen-AI) can be used to analyze user experience and network performance. For example, the Gen-AI can make predictions on the User Equipment (UE) user experience when moving to the LTE network versus staying on the SA network and can suggest steering the UE from the SA to LTE/NSA network. In one embodiment after a call or other communication session is completed, the UE can be kept on the LTE/NSA layer (e.g., for a particular time period) for a better user experience.

In one embodiment, FirstNet load-based management can be implemented. For example, for FirstNet users, after being steered to the LTE network, their UEs can be maintained on the LTE layer for a better user experience. This is particularly useful for high-priority use cases, such as first responders during an emergency event.

In one embodiment, differentiated treatment for different devices can be employed. For example, the system and methodology can recognize that device capabilities vary (e.g., high-end, low-end, new devices, legacy devices, etc.). For some devices under certain circumstances, LTE can provide a better user experience. The system and methodology can determine these particular circumstances and manage network steering to provide a better user experience which is based in part on the device capabilities.

In one embodiment, system and methodology can be applied in an Open-RAN environment. For example, rAPPs (RAN applications) or other functionality can steer traffic and decide to keep a UE on an LTE layer depending on the circumstances. This process can be facilitated by the Open-RAN architecture, which can include sharing of information between sectors and base stations to facilitate determining and predicting user experiences.

In one embodiment, particular Information Elements (IEs) can be employed during messaging such as between a UE and a network. For example, in conjunction with the ability of the system and methodology to employ a gNB (next-generation Node B) to steer a UE from the SA layer to the LTE/NSA layer, the system and methodology can include IEs in the messaging (e.g., IRAT (Inter-Radio Access Technology) Handover message and/or IRAT Release and Redirect RRC (Radio Resource Control) Release message) which indicate delayed return indication and which indicate a delayed return timer. For instance, these IEs can assist in managing the timing of the UE's return to the SA network, allowing for a delayed return mechanism.

In one embodiment, a delayed return mechanism can be employed. For example, the system and methodology can have the UE delay its return to the SA network, such as by ignoring a SIB 24 message (which would otherwise prompt an immediate return to SA). In one embodiment, the UE can exit the delayed return mode when the delayed return timer expires or when the UE is powered off/restarted. This mechanism helps prevent frequent and unnecessary switching, leading to more stable connections and reduced signaling overhead.

In one embodiment, the system and methodology can employ the delayed return mechanism to potentially save battery life by avoiding frequent network transitions, as the UE only exits the delayed return mode when necessary.

In one or more embodiments, the end user device can provide information that is utilized in determining a selection of the SA or NSA network and/or a selection of the delayed return timer. For example, a mobile phone can provide its battery power which can then be considered in a determination as to when the mobile phone should return to the SA network, which may save energy usage (e.g., through less messaging). In other embodiments, the end user device can play a more active role in the selection of the SA or NSA network and/or the selection of the delayed return timer, such as requesting a longer (or shorter) delayed return timer when the end user device knows that the user is scheduled for a video call to occur around the same time that the delayed return timer is set to expire. In one embodiment, the selection of the SA or NSA network and/or the selection of the delayed return timer can be a network-based decision. In one embodiment, the selection of the SA or NSA network and/or the selection of the delayed return timer can be an end user device-based decision. In one embodiment, the selection of the SA or NSA network and/or the selection of the delayed return timer can be a negotiation or mutual decision between the network and the end user device. One or more of the exemplary embodiments describe AI modeling being performed by a network device(s) (e.g., controller 185 of system 100), however, the AI modeling can be performed by various devices or combinations of devices, which can include the end user device.

In one or more embodiments, the system and methodology can include selecting bands and/or implementing carrier aggregation to improve performance for the communication session. For example, AI modeling can be applied to various data, including current network conditions, predicted future network conditions, device capabilities, known and/or predicted network events (e.g., maintenance, a live heavy traffic streaming event, etc.), and so forth. For instance, the selecting of the particular bands and/or implementing carrier aggregation can be applied when the network selection decision is made (i.e., one of the SA or NSA networks is selected) and/or when returning to the non-selected network (e.g., after the expiration of the Delayed Return Timer). Other embodiments are described in the subject disclosure.

One or more aspects of the subject disclosure include a method. The method can include analyzing, by a processing system including a processor, data by applying AI modeling to the data resulting in analyzed data, where the analyzing includes analyzing network conditions at a SA network and at an NSA network resulting in analyzed network conditions. The method can include predicting, by the processing system, a better user experience for a communication session of an end user device based on the analyzed data resulting in a prediction. The method can include selecting, by the processing system, one of the SA network or the NSA network for the end user device based on the prediction resulting in a selected network. The method can include determining, by the processing system, a time period for the end user device to continue utilizing the selected network for future communication sessions. The method can include providing, by the processing system, an instruction to a network element that causes the end user device to connect to the selected network. The end user device can utilize the selected network for the communication session and the future communication sessions during the time period.

One or more aspects of the subject disclosure include a device comprising a processing system including a processor; and a memory that stores executable instructions that, when executed by the processing system, facilitate performance of operations. The operations can include selecting one of a SA network or an NSA network for an end user device based on a prediction resulting in a selected network, where the prediction is based on an analysis of a communication session of the end user device utilizing a quality threshold, and where the analysis is based on at least one of capabilities of the end user device, network conditions at the SA network and at the NSA network, or an identification of a type of user of the end user device. The operations can include determining a time period for the end user device to continue utilizing the selected network for future communication sessions. The end user device can utilize the selected network for the communication session and the future communication sessions during the time period.

One or more aspects of the subject disclosure include a non-transitory machine-readable medium, comprising executable instructions that, when executed by a processing system including a processor of a communication device, facilitate performance of operations. The operations can include connecting to a selected network for a first communication session, where the selected network is one of a SA network or an NSA network and is selected based on a prediction according to an analysis of the first communication session, and where the analysis is based on at least one of capabilities of the communication device, network conditions at the SA network and at the NSA network, or an identification of a type of user of the communication device. The operations can include connecting to the selected network for a second communication session based on a determination that the second communication session is initiated before expiration of a time period.

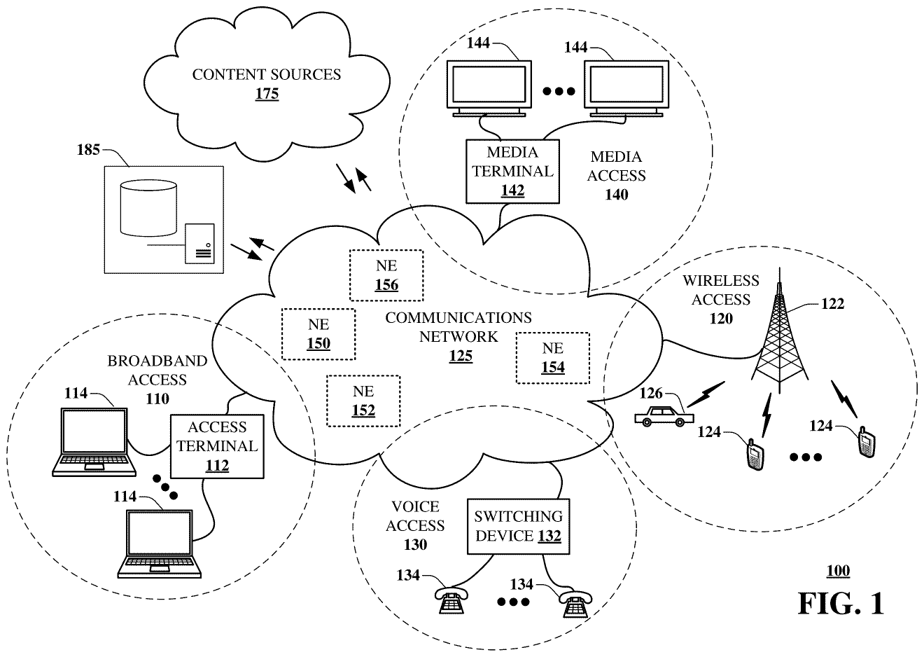

Referring now to FIG. 1, a block diagram is shown illustrating an example, non-limiting embodiment of a system 100 in accordance with various aspects described herein. System 100 can include a steering management controller or platform 185 that can perform various functions including managing steering between a Stand-Alone (SA) network and a non-standalone (NSA) network. The controller 185 can be various devices and combinations of devices, including servers, virtual machines, and so forth, which can operate in a centralized or distributed fashion. In one or more embodiments, the controller 185 can employ generative Artificial Intelligence (AI) (which can include Machine Learning (ML)) to facilitate the management. For instance, the controller 185 can apply AI modeling to determine whether a particular device and/or a particular service requested by the device should be on the SA network or on the NSA network. In other embodiments, the AI modeling can determine delay timers to be applied for when a UE should return to a particular one of the NSA or SA networks.

In one embodiment, where SA and LTE coverage exist, controller 185 can analyze user experience and/or network performance. This information can then be utilized for steering of the UE between the different networks. For instance, a determination and/or a prediction on UE user experience can be made with respect to moving to an LTE network as opposed to keeping the UE on the SA network and/or with respect to steering the UE from the SA to the LTE/NSA network. This prediction can include estimating the UE user experience on both networks over a particular time period utilizing factors such as actual and/or predicted network measurements, device capabilities, service type, on-going events, predicted events, and so forth. These predictions of UE user experience can then be compared (e.g., according to thresholds) to determine the SA or NSA steering. The predictions can include one or more of: which network to utilize, a band within the selected network to use, network slicing to be utilized, when to perform the steering (e.g., to or from the selected network), how long of a delay to be applied before returning from the selected network, or a combination thereof.

In one or more embodiments, after a communication session is completed (e.g., voice, video, audio, data and/or messaging), the controller 185 can determine whether to maintain the UE on the selected network (e.g., an LTE/NSA layer) if it is determined or predicted that a better user experience will occur. As explained herein, this determination or prediction can be made according to various factors that include current and predicted network metrics, a type of service that may be utilized by the UE, capabilities of the UE, and other factors. In one or more embodiments, this determination or prediction can be according to particular thresholds that can be one or more of: predetermined, dynamic, user-selected, network selected or a combination thereof. For example, the threshold can be based on one or more QoS thresholds for video streaming (e.g., latency, bandwidth, packet loss, jitter, video quality, audio quality, and/or adaptive bitrate) in a situation where it has been predicted that the UE would likely be utilized for video streaming in the future, and the thresholds can be determined for each of the available SA and NSA networks. In one embodiment, thresholds can be applied in combination, including based on cost effectiveness and network considerations, such as steering a UE to a particular network based on a threshold(s) and based on network load management factors, such as current or predicted traffic and the desire to lower that traffic on the non-selected network.

In one or more embodiments, the controller 185 can make a steering decision based on a type of user, a type of device and/or a type of service. For example, a FirstNet user can be identified where after the FirstNet user is steered to an LTE network based on a first determination as to user experience, then the FirstNet user may be maintained on the LTE network for better user experience. In one embodiment, this can be performed in conjunction with a delayed return timer that causes the UE to ignore any return commands or instructions (e.g., an SIB 24 message), which can include maintaining the UE on the selected network over the entire time period designated via the delayed return timer.

In one or more embodiments, device capabilities can vary including in devices that are high-end, low-end, new, legacy, etc. These factors can be utilized by the controller 185 in performing the steering management functions described herein. As an example, two UEs that are requesting the same service at the same time in the same area having the same types of subscriptions may be steered to different networks (SA and NSA) based on one of the UE's being an older device that lacks the capabilities of the other device and therefore will not be able to provide the same higher level of user experience when delivering the particular service on a preferred network.

In one or more embodiments, for some devices, an LTE network may provide a better use experience than a 5G SA network. This can depend on various factors and can change over time, including based on device capabilities, current and predicted network conditions, a type of service being provided, and so forth. Differentiated treatment for different devices to enable best user experience can be provided by the controller 185 in a number of different ways including based on application of AI modeling. In one or more embodiments, the controller 185 can operate in conjunction with (or be replaced by) an Open-RAN system in which rAPPs can steer network traffic and can decide to keep a UE on an LTE network.

In one embodiment, in conjunction with a gNB steering a UE from an SA network to an LTE/NSA network, Information Elements (IEs) can be utilized to facilitate management of this process. For example, IEs can be utilized in particular messaging used by the network (e.g., messaging that follows the 3GPP standard) such as adding IEs to an IRAT Handover message and/or an IRAT Release and Redirect RRC Release message. These IEs can include an IE for a delayed return indication and/or an IE for a delayed return timer. For instance, a UE can delay a return to SA, ignore commands otherwise such as an SIB24 message (i.e., not returning to SA immediately). In one embodiment, a UE may leave the delayed return mode when a delayed return timer expires and/or when a UE powers off or restarts.

In one or more embodiments, System Information Blocks (SIBs) can be used by system 100 with messages to broadcast or otherwise transmit information to UEs. SIBs can be part of the Radio Resource Control (RRC) protocol and can be used to convey various types of system information necessary for the UE to access and operate within the network. For example, a SIB 24 is a message used in 5G networks to provide information related to inter-RAT mobility. This can include parameters that control the UE's behavior when switching between different types of networks, such as from a SA 5G network to an NSA network, or vice versa.

In one or more embodiments, in the context of controlling a UE's switching between an SA network and an NSA network, messaging can include parameters such as:
Thresholds: Signal quality thresholds that determine when the UE should consider switching from one network to another. For example, if the signal quality of the SA network falls below a certain threshold, the UE may be instructed to switch to the NSA network.
Timers: Timers that control the delay before the UE switches back to the SA network after being moved to the NSA network. This can help prevent frequent and unnecessary switching, which can lead to network instability and increased signaling overhead.
Prioritization: Information on the prioritization of different networks, which can help the UE decide which network to connect to based on current network conditions and policies.

By configuring these parameters in messaging, network operators can manage the UE's mobility behavior more effectively, ensuring a better user experience and optimized or improved network performance. For instance, a delayed return mechanism can be employed which involves a UE ignoring the SIB 24 message (which indicates that the UE is to switch back to the SA network) to prevent immediate switching back to the SA network, thereby maintaining a more stable connection on the NSA network until certain conditions are met, such as the expiration of a delayed return timer or a device restart. In one or more embodiments, delayed return timers can be adjusted or replaced, such as a first prediction that results in a UE being told (by way of receiving a 15 minute delayed return timer) that the UE is to stay on the LTE/NSA network for the next 15 minutes including for new services being requested by the UE during that time period. However, a second prediction may be generated that results in the UE being told (by way of receiving a 45 minute delayed return timer) that the UE is to stay on the LTE/NSA network for the next 45 minutes including for new services being requested by the UE during that time period. For instance, the second prediction may be based on an occurrence of an unexpected event (e.g. a network outage resulting in increase of network traffic in the SA network) that was unknown at the time of the first prediction.

For example, system 100 can facilitate in whole or in part analyzing data by applying AI modeling to the data where the analyzing includes analyzing network conditions at a SA network and an NSA network resulting in analyzed network conditions; predicting a better user experience for a communication session of an end user device based on the analyzed data resulting in a prediction; selecting one of the SA network or the NSA network for the end user device based on the prediction resulting in a selected network; determining a time period for the end user device to continue utilizing the selected network for future communication sessions; and providing an instruction to a network element that causes the end user device to connect to the selected network, where the end user device utilizes the selected network for the communication session and the future communication sessions during the time period.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In system 100, the controller 185 interacts with the communications network 125 to manage the selection between an SA network and an NSA network by applying AI modeling to information associated with the various network elements (NE) 150, 152, 154, 156, which facilitate different types of access such as broadband access 110, wireless access 120, voice access 130, and media access 140.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

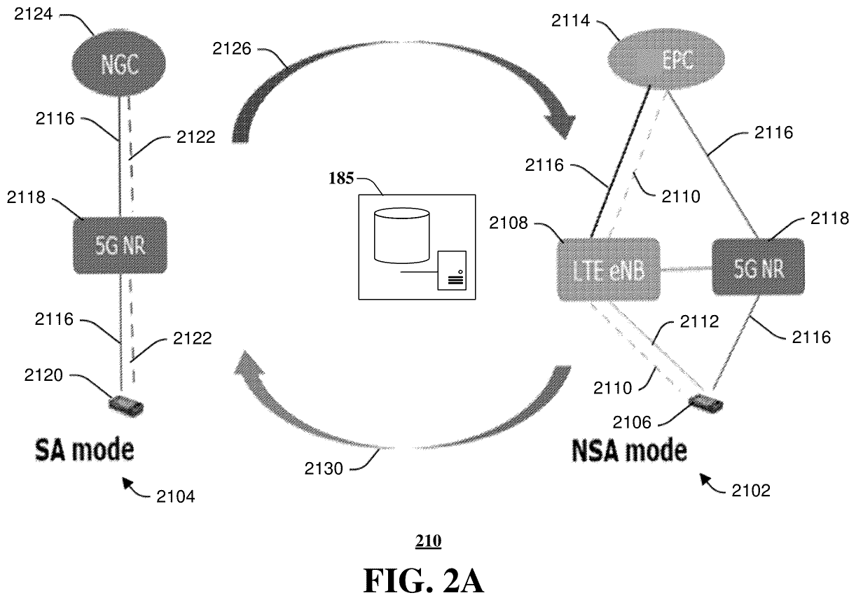

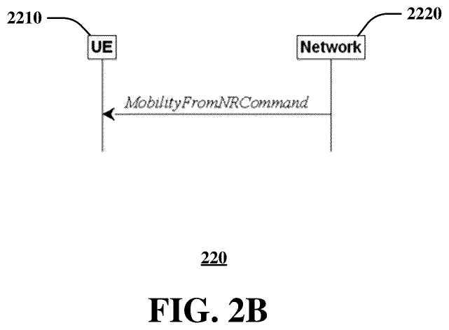

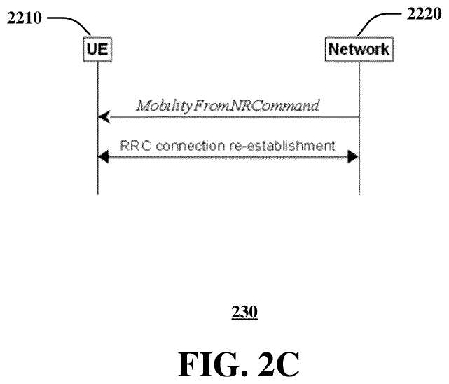

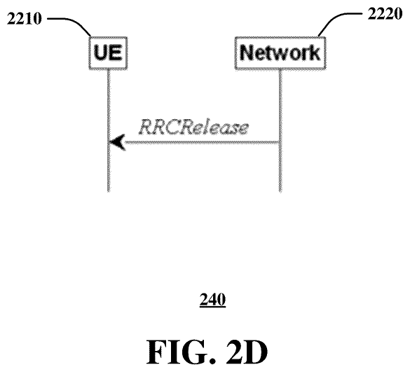

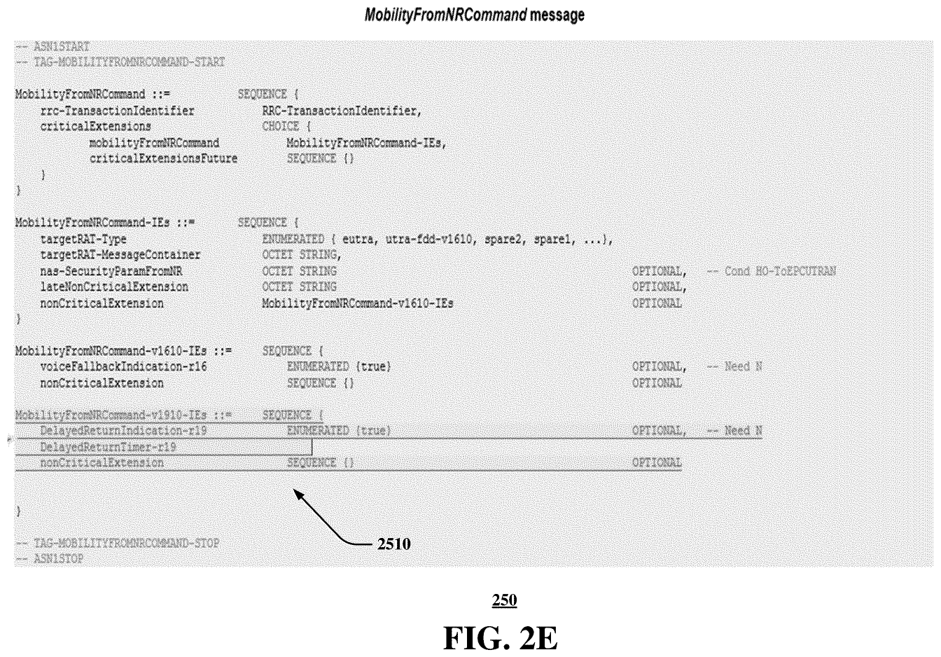

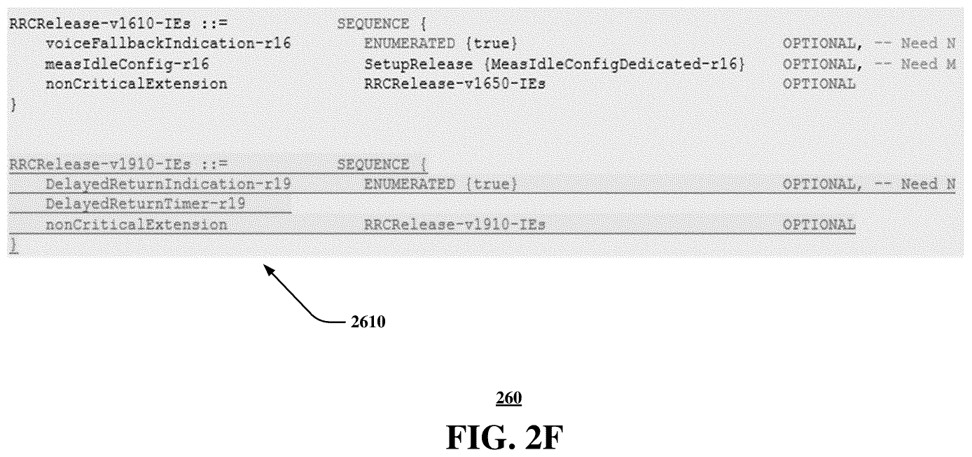

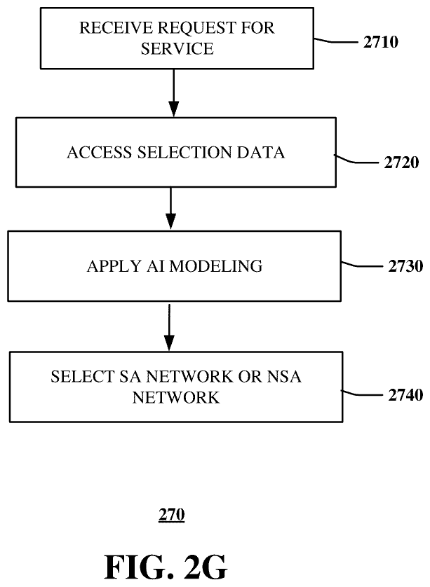

FIG. 2A is a block diagram illustrating an example, non-limiting embodiment of a system 210 functioning within the communication network of FIG. 1 in accordance with various aspects described herein. Communication network 210 illustrates an NSA network (or mode) 2102 and an SA network (or mode) 2104 for advanced communications networks. It should be understood that the SA and NSA networks 2102 and 2104 are also called modes herein since they can be configured in various ways utilizing various components and functionality including cloud computing. It should also be understood that the SA and NSA networks 2102, 2104 can operate according to various RATs, which in this example is illustrated as the SA being a 5G network and the NSA being an LTE/NSA network. In other embodiments, the RATs can be different including the SA being a 6G network and the NSA being a 5G/NSA network.

As an example, the controller 185 performs one or more of the following functions: (1) Analyzing Network Conditions: The controller 185 can collect data from the network elements (e.g., NE 150, 152, 154, 156 within the communications network 125 of FIG. 1). This data includes network performance metrics such as signal strength, network congestion, latency, and throughput for both the SA and NSA networks. (2) Applying AI Modeling: The controller 185 can apply AI modeling to the collected data to analyze the current and predicted network conditions. The AI modeling includes machine learning algorithms that consider historical user experience data and network performance metrics to make predictions about user experience on both the SA and NSA networks. (3) Predicting User Experience: Based on the AI modeling, the controller 185 can predict the user experience for an end user device when connected to either the SA network or the NSA network. The prediction includes evaluating factors such as signal strength, network congestion, latency, and throughput. (4) Selecting the Network: The controller 185 can select either the SA network or the NSA network for the end user device based on the prediction of a better user experience. The selection is communicated to the end user device. (5) Determining the Delayed Return Timer: The controller 185 can determine a delayed return timer for the end user device to stay on the selected NSA network for a pre-defined time period. This timer can be based on the AI modeling and the predicted network conditions. The delayed return timer helps prevent frequent and unnecessary switching between the SA and NSA networks, leading to a more stable connection and optimized user experience. (6) Incorporating Information Elements (IEs): The controller 185 can incorporate new IEs in messaging such as the IRAT Handover message and the IRAT Release and Redirect RRC Release message. Other messages can also be utilized and include the IEs. These IEs can include a delayed return indication and a delayed return timer, which instruct the end user device to delay its return to the SA network by ignoring a SIB24 message until the delayed return timer expires or the device is powered off/restarted. By performing these functions, the controller 185 ensures that the end user device is connected to the network that provides the best user experience while optimizing network performance and reducing signaling overhead.

The illustrated NSA mode 2102 comprises a UE 2106 that connects to first network equipment (e.g., LTE eNB equipment 2108) via an LTE C-plane 2110 and an LTE U-plane 2112. The LTE eNB equipment 2108 communicates to an EPC 2114 via the LTE C-Plane 2110 and a 5G U-plane 2116. In addition, the UE 2106 connects to second network equipment (e.g., 5G NR equipment 2118) via the 5G U-plane 2116. The 5G NR equipment 2118 communicates with the EPC 2114 via the 5G U-plane 2116.

The illustrated SA mode 2104 comprises equipment 2120 that communicates to the 5G NR equipment 2118 via the 5G U-plane 2116 and a 5G C-plane 2122. The 5G NR equipment 2118 communicates with a Next Generation Core (NGC 2124) via the 5G U-plane 2116 and the 5G C-plane 2122. In one or more embodiments, the controller 185 can include network selection and return (represented by the arrows 2126 and 2130) as described herein according to the various techniques and the Delayed Return Timer.

In one embodiment, network congestion aware logic 2128 can be utilized to determine signaling and traffic load status in the network (e.g., whether there is congestion). In other embodiments, the logic 2128 can be integrated with the operation of the controller 185. The signaling and traffic load status can be the respective statuses of the LTE and 5G SA signaling and traffic. In another embodiment, the determination of the signaling and traffic load status can be performed by the LTE eNB 2108 (e.g., LTE scheduler). In one embodiment, network congestion aware logic 2128 can be implemented before, during and after a “Radio Resource Control (RRC) Release and Redirect” and/or an “IRAT Handover” is triggered.

FIG. 2B shows a communication process 220 involving a UE 2210 and a network 2220 by way of interaction between these components through a MobilityFromNRCommand message. UE 2210 represents a user equipment that communicates with the network 2220. UE 2210 can be any device capable of connecting to a network, such as a mobile phone, tablet, IoT device, or other wireless communication device. UE 2210 receives commands and data from the network 2220 to manage the connectivity and operations of UE 2210. Network 2220 is the network infrastructure that interacts with UE 2210. Network 2220 can include various network elements such as base stations, servers, and other components that facilitate communication and data exchange with UE 2210. Network 2220 sends commands and information to UE 2210 to control network access and performance.

MobilityFromNRCommand message is a specific command sent from Network 2220 to UE 2210 that can instruct (or facilitate) the UE 2210 to perform certain actions related to mobility management, such as transitioning between different network layers or technologies. MobilityFromNRCommand messages ensure that UE 2210 maintains optimal connectivity and performance based on the current network conditions and requirements.

In one or more embodiments, the MobilityFromNRCommand message (or another message in other embodiments), can include one or more IEs that facilitate the management of network selection for the UE 2210. For example, the message can include one or both of a DelayedReturnTimer (e.g., a time period for the UE 2210 to remain utilizing the selected network) or a DelayedReturnIndicator (e.g., instruction causing the UE 2210 to ignore an instruction to return to utilizing the SA network).

FIG. 2C illustrates a communication process 220 involving a UE 2210 and a Network 2220 by way of the interaction between these components through a MobilityFromNRCommand message and an RRC connection re-establishment message. UE 2210 represents a user equipment that communicates with network 2220. UE 2210 can be any device capable of connecting to a network, such as a mobile phone, tablet, IoT device, or other wireless communication device. UE 2210 receives commands and data from network 2220 to manage the connectivity and operations of UE 2210. Network 2220 is the network infrastructure that interacts with UE 2210. Network 2220 can include various network elements such as base stations, servers, and other components that facilitate communication and data exchange with UE 2210. Network 2220 sends commands and information to UE 2210 to control network access and performance.

The RRC connection re-establishment message is a component of the RRC protocol, which is responsible for the control plane signaling between the UE 2210 UE and the network 2220. The RRC connection re-establishment message serves several important functions: (1) Re-establishing RRC Connection: The primary purpose of the RRC connection re-establishment message is to re-establish an RRC connection that has been lost or interrupted. This can occur due to various reasons such as radio link failure, handover failure, or other issues that cause the UE to lose its connection with the network. (2) Resuming Data Transfer: Once the RRC connection is re-established, the UE 2210 can resume data transfer with the network 2220. This ensures that ongoing communication sessions, such as voice calls, video calls, or data transfers, can continue without significant disruption. (3) Re-synchronizing with the Network: The RRC connection re-establishment message helps the UE 2210 to re-synchronize with the network 2220. This includes re-establishing the security context, updating the UE's context information, and ensuring that the UE 2210 is properly aligned with the network's timing and frequency parameters. (4) Maintaining QoS: The re-establishment of the RRC connection helps maintain the QoS for ongoing communication sessions. By quickly re-establishing the connection, the network 2220 can ensure that the QoS parameters, such as latency, throughput, and reliability, are maintained for the UE's active sessions. (5) Handling Mobility: The RRC connection re-establishment message is also used during mobility events, such as handovers between cells or different RATs. It ensures that the UE can seamlessly transition between different network nodes while maintaining an active RRC connection. Overall, the RRC connection re-establishment message is a mechanism in wireless networks that ensures the continuity and reliability of the UE's connection with the network, even in the face of disruptions or mobility events.

FIG. 2D illustrates a communication process 240 involving a UE 2210 and a network 2220 by way of interaction between these components through an RRCRelease message. UE 2210 represents a user equipment that communicates with network 2220. UE 2210 can be any device capable of connecting to a network, such as a mobile phone, tablet, IoT device, or other wireless communication device. UE 2210 receives commands and data from network 2220 to manage the connectivity and operations of UE 2210. Network 2220 is the network infrastructure that interacts with UE 2210. Network 2220 can include various network elements such as base stations, servers, and other components that facilitate communication and data exchange with UE 2210. Network 2220 sends commands and information to UE 2210 to control network access and performance.

RRCRelease message is a specific command sent from Network 2220 to UE 2210. This command instructs UE 2210 to perform certain actions related to mobility management, such as transitioning between different network layers or technologies. RRCRelease message ensures that UE 2210 maintains optimal connectivity and performance based on the current network conditions and requirements.

In one or more embodiments, the RRCRelease message (or another message in other embodiments), can include one or more IEs that facilitate the management of network selection for the UE 2210. For example, the message can include one or both of a DelayedReturnTimer (e.g., a time period for the UE 2210 to remain utilizing the selected network) or a DelayedReturnIndicator (e.g., instruction causing the UE 2210 to ignore an instruction to return to utilizing the SA network).

FIG. 2E illustrates content of a MobilityFromNRCommand message 250. The content can include various components such as rrc-TransactionIdentifier, criticalExtensions, MobilityFromNRCommand-IEs, targetRAT-Type, targetRATMessageContainer, nas-SecurityParamFromNR, laterNonCriticalExtension, nonCriticalExtension, MobilityFromNRCommand-v1610-IEs, voiceFallbackIndication-r16, MobilityFromNRCommand-v 910-IEs, DelayedReturnIndication-r19 2510, DelayedReturnTimer-r19, and nonCriticalExtension.

The DelayedReturnIndication-r19 2510 is an enumerated type that indicates whether the delayed return mechanism is enabled. In one embodiment, this component is or can be designated as optional and can be used to manage the timing of the user equipment's return to a non-selected network (e.g., the SA network). The DelayedReturnTimer-r19 2510 information can be used by the UE to determine when the UE can return to the non-selected network.

FIG. 2F illustrates IEs within an RRCRelease message 260, including the DelayedReturnIndication-r19 2610. FIG. 2F illustrates the structure and optional nature of these IEs within the context of the RRCRelease-v1910-IEs. The sequence also includes other elements such as DelayedReturnTimer-r19 and nonCriticalExtension. These elements work together to provide a comprehensive set of instructions for managing the user equipment's behavior during network transitions, ensuring optimal connectivity and performance based on current network conditions and requirements.

FIG. 2G illustrates a method 270 for managing switching between SA and NSA networks (or operations). At 2710, a request for service can be received. For example, the process can begin with receiving a request for service from a UE. This request can be for initiating a communication session such as a voice call, video call, data transfer, or any other type of service that requires network connectivity. At 2720, various selection data can be accessed or obtained. For example, upon receiving the request for service, the system (e.g., controller 185 of FIG. 1) accesses selection data. This data can include information related to current or future network conditions, user experience metrics, device capabilities, and other relevant parameters that will be used in the decision-making process.

At 2730, AI modeling can be applied. For example, the system can apply AI modeling to the accessed selection data, which can involve analyzing the current and predicted network conditions at both the SA and NSA networks. It can also include evaluating factors such as signal strength, network congestion, latency, and throughput to predict the user experience for the UE on both networks. At 2740, one of the SA Network or NSA Network can be selected for use by the end user device. For example, based on the AI modeling and the predicted user experience, the system can select either the SA network or the NSA network to ensure a better or best possible user experience and/or optimized network performance. In one embodiment, the selection of a better user experience can be based on one or more thresholds that are compared to current and predicted metrics for the SA and NSA networks. The selection of the network can then be communicated to the UE, instructing the UE to connect to the chosen network.

In one or more embodiments, the method 270 can include analyzing of the network conditions by predicting future network conditions for the SA and NSA networks. As an example, the selecting of one of the SA or NSA networks and/or the determining of the time period can be based on the predicting of the future network conditions. In one or more embodiments, the method 270 can include the time period is communicated to the end user device in an information element. In one or more embodiments, the method 270 can include the information element being at least one of a MobilityFromNRCommand message or an RRCRelease message. In one or more embodiments, the method 270 can include the information element including a DelayedReturnIndicator that causes the end user device to ignore an instruction to return to utilizing the SA network associated with a network message (e.g., a SIB24).

In one or more embodiments, the method 270 can include analyzing of the data by applying the AI modeling based in part on analyzing device capabilities. In one or more embodiments, the method 270 can include analyzing of the data including determining at least one of whether the communication session is associated with a public safety service or whether a user of the end user device is a first responder. In one or more embodiments, the method 270 can include analyzing of the network conditions including determining a frequency or band to be utilized for at least one of the communication session or the future communication sessions. In one or more embodiments, the method 270 can include analyzing of the network conditions including determining one or more network slices to be utilized for the communication session and/or the future communication sessions.

In one or more embodiments, the method 270 can include analyzing of the network conditions including obtaining information from one or more network elements operating in an open RAN architecture. In one or more embodiments, the method 270 can include the predicting of the better user experience being based on one or more thresholds, where the determining of the time period can be based on predicting of first future network conditions. The method 270 can further include predicting second future network conditions during the time period after the predicting of the first future network conditions; and adjusting the time period according to the second future network conditions.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, the system and methodology provides a FirstNet use case in which a user can be offloaded from SA to LTE due to high load and can be maintained on the LTE network for a particular period of time as described herein even after the UE enters an idle mode and then tries to establish a subsequent communication session (during the Delayed Return Time Period).

In one or more embodiments, the system and methodology provides an interference mitigation scenario in which a user, due to quality reasons, has been moved from SA carrier to the LTE carrier, such as due to interference. The UE can be maintained on the LTE carrier for some particular time period until a trigger condition is reduced or the interference issue resolved. In this example, an initial Delayed Return Timer can be calculated according to a prediction as to when the interference issue will be resolved. Subsequent (or adjusted) Delayed Return Timers can be utilized and provided to the UE to extend the time period that the UE remains on the LTE carrier.

In one or more embodiments, the system and methodology can be applied to fixed wireless home internet services (e.g., home Wi-Fi delivered over a wireless network), in which a selection can be made between the SA and NSA networks and a Delayed Return Timer can be calculated or predicted accordingly.

In one or more embodiments, the system and methodology can be applied to RedCap (5G Reduced Capability) networks, such as a RedCap SA on n5 interfaces (e.g., SA can be provided on certain sites where N77 and N5 interfaces exist). In this example, SA can be available on n5 interfaces only for RedCap devices and eMBB users can be moved to LTE networks. In this example, once a user comes to the LTE network from an SA network such as due to IRAT how long the user remains can be managed as described herein. In one embodiment, a user group profile can be utilized to determine how that user is to remain on the LTE network without returning or otherwise switching to the SA network (e.g., according to a SIB24 message). In some embodiments, eMBB traffic may be maintained on the LTE network until an SA network is launched on the particular site with an N77 interface for the eMBB traffic.

In one or more embodiments, the system and methodology provides management for SA and NSA switching for network optimization. There are a number of features that allow for moving traffic from SA to LTE such as an NR SA BW triggered Inter-System Handover and NR SA UE Group Framework (IMEI-SV and Chipset ID) etc. These features are quite useful especially when it comes to for example venue locations where only mmWave communications are available to do NRDC, particularly where there are multiple FDD carriers for the LTE network but limited (e.g., only one) FDD carrier on the SA network. As an example, for certain low end devices that do not support NRDC, it can be beneficial to move them to the LTE network where they can perform Carrier Aggregation instead of keeping them on the single SA carrier. However, current systems have an SIB24 message set on the LTE network after the first communication session is established which would currently cause the UE to reselect back to the SA network. In one or more embodiments, the system and methodology prevents this unwanted return to the SA network even for a subsequent communication session after the UE enters an idle mode through use of a Delayed Return Timer and a Delayed Return Indicator (which can be included in IEs delivered to the UE) as described herein.

In one or more embodiments, the system and methodology provides Gen-AI Assisted Delayed Return to an SA network which can improve load balancing and interference mitigation, and can allow for particular devices to experience a higher throughput on the LTE/NSA network. A delayed return can be implemented such as the UE staying on the LTE network until a timer expires. Gen-AI can suggest and trigger traffic steering from SA to LTE. Gen-AI can dynamically adjust the timer based on network traffic, resource, interference changes, or other factors including current and predicted conditions associated with both of the SA and NSA networks.

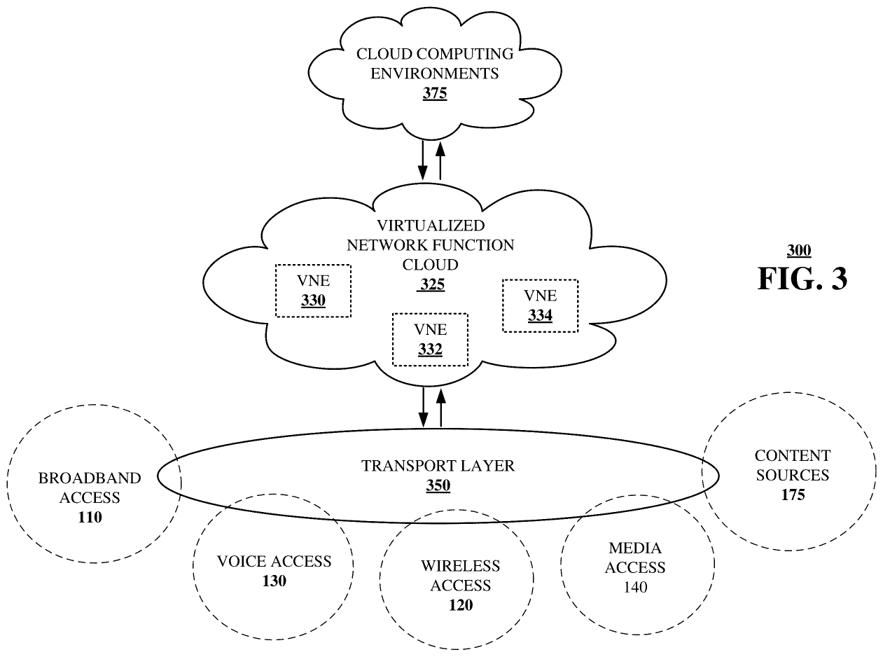

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions described herein. For example, virtualized communication network 300 can facilitate in whole or in part analyzing data by applying AI modeling to the data where the analyzing includes analyzing network conditions at a SA network and an NSA network resulting in analyzed network conditions; predicting a better user experience for a communication session of an end user device based on the analyzed data resulting in a prediction; selecting one of the SA network or the NSA network for the end user device based on the prediction resulting in a selected network; determining a time period for the end user device to continue utilizing the selected network for future communication sessions; and providing an instruction to a network element that causes the end user device to connect to the selected network, where the end user device utilizes the selected network for the communication session and the future communication sessions during the time period.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

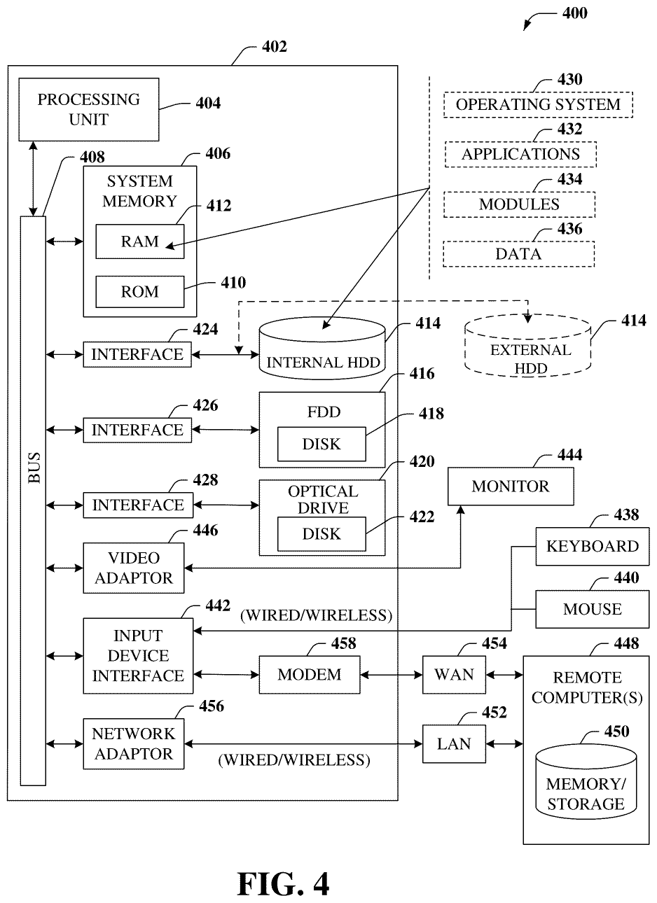

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part analyzing data by applying AI modeling to the data where the analyzing includes analyzing network conditions at a SA network and an NSA network resulting in analyzed network conditions; predicting a better user experience for a communication session of an end user device based on the analyzed data resulting in a prediction; selecting one of the SA network or the NSA network for the end user device based on the prediction resulting in a selected network; determining a time period for the end user device to continue utilizing the selected network for future communication sessions; and providing an instruction to a network element that causes the end user device to connect to the selected network, where the end user device utilizes the selected network for the communication session and the future communication sessions during the time period.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

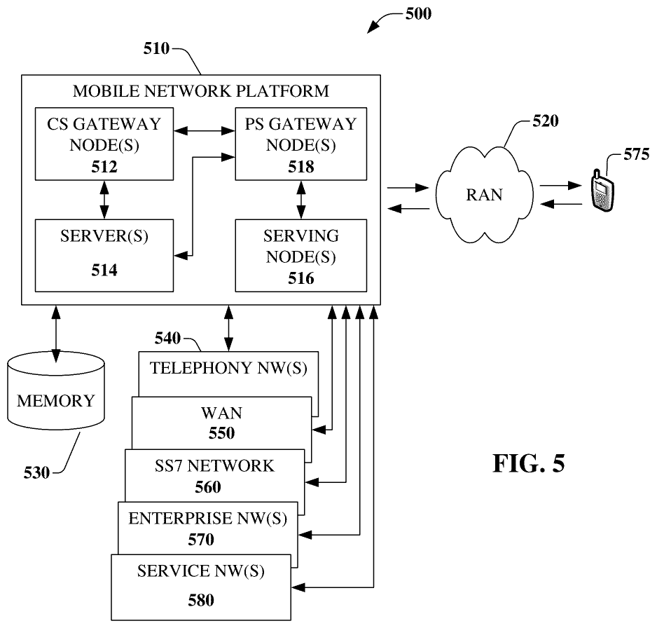

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part analyzing data by applying AI modeling to the data where the analyzing includes analyzing network conditions at a SA network and an NSA network resulting in analyzed network conditions; predicting a better user experience for a communication session of an end user device based on the analyzed data resulting in a prediction; selecting one of the SA network or the NSA network for the end user device based on the prediction resulting in a selected network; determining a time period for the end user device to continue utilizing the selected network for future communication sessions; and providing an instruction to a network element that causes the end user device to connect to the selected network, where the end user device utilizes the selected network for the communication session and the future communication sessions during the time period.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

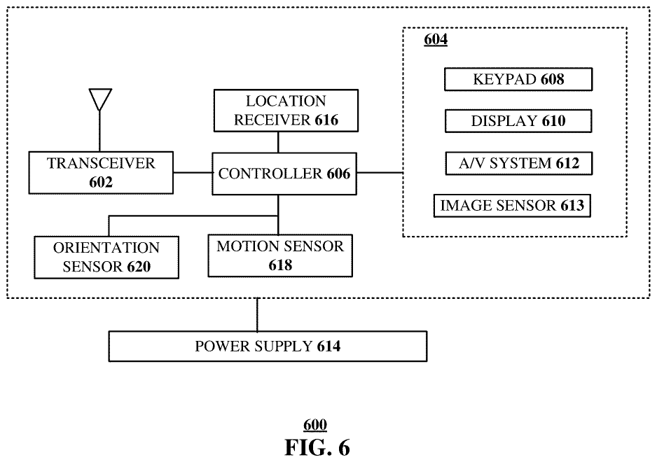

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part analyzing data by applying AI modeling to the data where the analyzing includes analyzing network conditions at a SA network and an NSA network resulting in analyzed network conditions; predicting a better user experience for a communication session of an end user device based on the analyzed data resulting in a prediction; selecting one of the SA network or the NSA network for the end user device based on the prediction resulting in a selected network; determining a time period for the end user device to continue utilizing the selected network for future communication sessions; and providing an instruction to a network element that causes the end user device to connect to the selected network, where the end user device utilizes the selected network for the communication session and the future communication sessions during the time period.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
analyzing, by a processing system including a processor, data by applying Artificial Intelligence (AI) modeling to the data resulting in analyzed data, wherein the analyzing includes analyzing network conditions at a Standalone (SA) network and at a Non-standalone (NSA) network resulting in analyzed network conditions;
predicting, by the processing system, a better user experience for a communication session of an end user device based on the analyzed data resulting in a prediction;
selecting, by the processing system, one of the SA network or the NSA network for the end user device based on the prediction resulting in a selected network;
determining, by the processing system, a time period for the end user device to continue utilizing the selected network for future communication sessions; and
providing, by the processing system, an instruction to a network element that causes the end user device to connect to the selected network,
wherein the end user device utilizes the selected network for the communication session and the future communication sessions during the time period.

2. The method of claim 1, wherein the analyzing of the network conditions includes predicting future network conditions for the SA and NSA networks, and wherein the determining of the time period is based on the predicting of the future network conditions.

3. The method of claim 1, wherein the time period is communicated to the end user device in an information element.

4. The method of claim 3, wherein the information element is at least one of a MobilityFromNRCommand message or an RRCRelease message.

5. The method of claim 4, wherein the information element includes a DelayedReturnIndicator that causes the end user device to ignore an instruction to return to utilizing the SA network associated with a SIB24 message.

6. The method of claim 1, wherein the analyzing of the data by applying the AI modeling includes analyzing device capabilities.

7. The method of claim 1, wherein the analyzing of the data includes determining at least one of whether the communication session is associated with a public safety service or whether a user of the end user device is a first responder.

8. The method of claim 1, wherein the analyzing of the network conditions includes determining a frequency to be utilized for at least one of the communication session or the future communication sessions.

9. The method of claim 1, wherein the analyzing of the network conditions includes obtaining information from one or more network elements operating in an open RAN architecture.

10. The method of claim 1, wherein the predicting of the better user experience is based on one or more thresholds, wherein the determining of the time period is based on predicting of first future network conditions, and further comprising:
predicting second future network conditions during the time period after the predicting of the first future network conditions; and
adjusting the time period according to the second future network conditions.

11. A device, comprising;
a processing system including a processor; and
a memory that stores executable instructions that, when executed by the processing system, facilitate performance of operations, the operations comprising:
selecting one of a Standalone (SA) network or a Non-standalone (NSA) network for an end user device based on a prediction resulting in a selected network, wherein the prediction is based on an analysis of a communication session of the end user device utilizing a quality threshold, wherein the analysis is based on at least one of capabilities of the end user device, network conditions at the SA network and at the NSA network, or an identification of a type of user of the end user device; and
determining a time period for the end user device to continue utilizing the selected network for future communication sessions,
wherein the end user device utilizes the selected network for the communication session and the future communication sessions during the time period.

12. The device of claim 11, wherein the analysis includes predicting future network conditions for the SA and NSA networks, and wherein the determining of the time period is based on the predicting of the future network conditions.

13. The device of claim 11, wherein the time period is communicated to the end user device in an information element.

14. The device of claim 13, wherein the information element is at least one of a MobilityFromNRCommand message or an RRCRelease message.

15. The device of claim 14, wherein the information element includes a DelayedReturnIndicator that causes the end user device to ignore an instruction to return to utilizing the SA network associated with a network message.

16. The device of claim 11, wherein the analysis of the communication session is based on applying AI modeling.

17. The device of claim 11, wherein the identification of the type of user of the end user device includes determining at least one of whether the communication session is associated with a public safety service or whether a user of the end user device is a first responder.

18. The device of claim 1, wherein the analysis of the communication session includes determining a frequency to be utilized for at least one of the communication session or the future communication sessions.

19. The device of claim 1, wherein the analysis of the communication session includes obtaining information from one or more network elements operating in an open RAN architecture.

20. A non-transitory machine-readable medium, comprising executable instructions that, when executed by a processing system including a processor of a communication device, facilitate performance of operations, the operations comprising:
connecting to a selected network for a first communication session, wherein the selected network is one of a Standalone (SA) network or a Non-standalone (NSA) network and is selected based on a prediction according to an analysis of the first communication session, wherein the analysis is based on at least one of capabilities of the communication device, network conditions at the SA network and at the NSA network, or an identification of a type of user of the communication device; and
connecting to the selected network for a second communication session based on a determination that the second communication session is initiated before expiration of a time period.
